(19) United States
(12) Patent Application Publication
(10) Pub. No.: US 2004/0061493 A1
(43) Pub. Date: Apr. 1, 2004

(54) Tone wheel

(76) Inventors: Keith Fishburn, Berea, OH (US); Rudy J. Heimann Jr, Brunswick, OH (US); Michael G. Nejman, Avon, OH (US)

Correspondence Address: PEARNE & GORDON LLP, 1801 EAST 9TH STREET, SUITE 1200, CLEVELAND, OH, 44114-3108, US

(21) Appl. No.: 09/959,292

(22) PCT Filed: Sep. 25, 2001
(86) PCT No.: PCT/US01/29969

(51) Int. Cl. G01P 3/48

(52) U.S. Cl. 324/173; 324/207.22

(57) ABSTRACT

A tone wheel for generating electrical pulses at a rate proportional to the rotational speed of a road wheel. The tone wheel is stamped from sheet steel stock and is characterized by elongated, axially extending teeth supported in cantilever fashion from one end on roots extending radially from a center portion of the tone wheel. The teeth are spaced from each other and for a major portion of their length are free of adjacent structure so that they produce a sharp pulse when scanned by a sensor and are self-cleaning to reduce the risk of accumulating dirt and debris which can otherwise result in destruction of the sensor.

### SUMMARY OF THE INVENTION

The invention relates to improvements in tone wheels used to generate signals that correspond to the rate of rotation of a wheel or wheels of a land vehicle.

### BACKGROUND OF THE INVENTION

It is known to provide a ferromagnetic toothed wheel or tone wheel to generate with a sensor an electrical signal that effectively instantaneously indicates rotational speed of a wheel in an automobile or other land vehicle. This information can be used to determine, among other things, that a particular wheel or wheels is/are skidding and to modulate the braking forces on the wheel or wheels to reduce or eliminate the skidding condition. A tone wheel can also be used in wheeled land vehicles to generate signals for a traction control system.

The accuracy of the signal depends, in part, on the accuracy of the formation of the teeth. It is important that the teeth are not only uniformly spaced about the periphery of a wheel, but also that the cross-sectional shape of each tooth is the same as all others and that the tooth profile is characterized by relatively sharp edges.

It is known to produce powder metal tone wheels. These prior art products have demonstrated that they are prone to accumulate oil, grease and debris between adjacent teeth. This accumulation, which can include metallic dust, diminishes the quality of the signal that the associated sensor can produce ultimately to a point where the anti-skid system fails to work properly. Foreign objects can become lodged between adjacent teeth on the tone wheel, which look like annular gears, and when such objects are carried past a sensor they may strike and break it or may abrade it to the point of destruction. An additional problem with powdered metal tone wheels is that they are susceptible to cracking in service in part due to residual stresses that occur when they are press-fit onto a shaft or other part. These cracked parts may produce error signals rendering the anti-skid system inoperative.

### SUMMARY OF THE INVENTION

The invention provides an improved tone wheel fabricated from sheet steel in a configuration that produces an improved signal and is stronger, lighter and more cost effective than prior art products. Still further, the tone wheel of the invention reduces the risk of damage to the sensor associated with it.

As disclosed, the tone wheel has a multitude of evenly spaced axially oriented teeth at its periphery or rim. The teeth are supported in cantilever fashion from a wheel center portion so that the center portion has negligible influence on the signal being produced by the sensor. The tone wheel thus exhibits clear transitions between the presence and absence of a tooth in its scanned area.

More particularly, the tone wheel, formed from ferromagnetic malleable steel, assures that it will provide a long service life without risk of fracture through brittleness or fatigue. The inherent strength of the steel allows the wheel to be fabricated with relatively light gauge stock so as to reduce weight while retaining strength. The malleable steel is economical in cost and can be fabricated by relatively inexpensive stamping techniques.

In the illustrated forms of the tone wheel, the teeth are free of interconnected webs in the area scanned by the sensor. Consequently, since there is no structure between the teeth in the relevant areas, foreign material cannot readily build-up in the gaps between the teeth. Thus, there is a greatly reduced risk of damage to the sensor by abrasion or impact with foreign material which could otherwise accumulate or become lodged in the areas between the teeth. The open network of the teeth, as well as the improved signal generating character of the teeth, is augmented by an arrangement where the teeth are supported on roots which are formed on the outer periphery of the center portion of the wheel. The roots have intervening areas that are angularly aligned with the slots between the rim teeth. The resulting wheel configuration is devoid of any ferromagnetic material angularly between the teeth even at their juncture with the roots so that the open lattice or network of the teeth is maintained along their full length.

### BRIEF DESCRIPTION OF THE DRAWINGS

FIG. 1 is a side elevational view of a first embodiment of a tone wheel constructed in accordance with the invention;

FIG. 1A is an enlarged fragmentary view of a portion of the tone wheel;

FIG. 2 is a cross-sectional view of the tone wheel taken in the plane indicated at 2-2 in FIG. 1;

FIG. 3 is a cross-sectional view of a wheel suspension area of a land vehicle and the assembled relationship of the tone wheel of FIGS. 1-2 to this structure;

FIG. 4 is a side elevational view of a second embodiment of a tone wheel constructed in accordance with the invention;

FIG. 4A is an enlarged fragmentary view of a portion of the tone wheel of FIG. 4;

FIG. 5 is a cross-sectional view of the tone wheel taken in the plane indicated at 5-5 in FIG. 4; and

FIG. 6 is a cross-sectional view of a wheel suspension area of a land vehicle and the assembled relationship of the tone wheel of FIGS. 4-5 to this structure.

### DESCRIPTION OF THE PREFERRED EMBODIMENTS

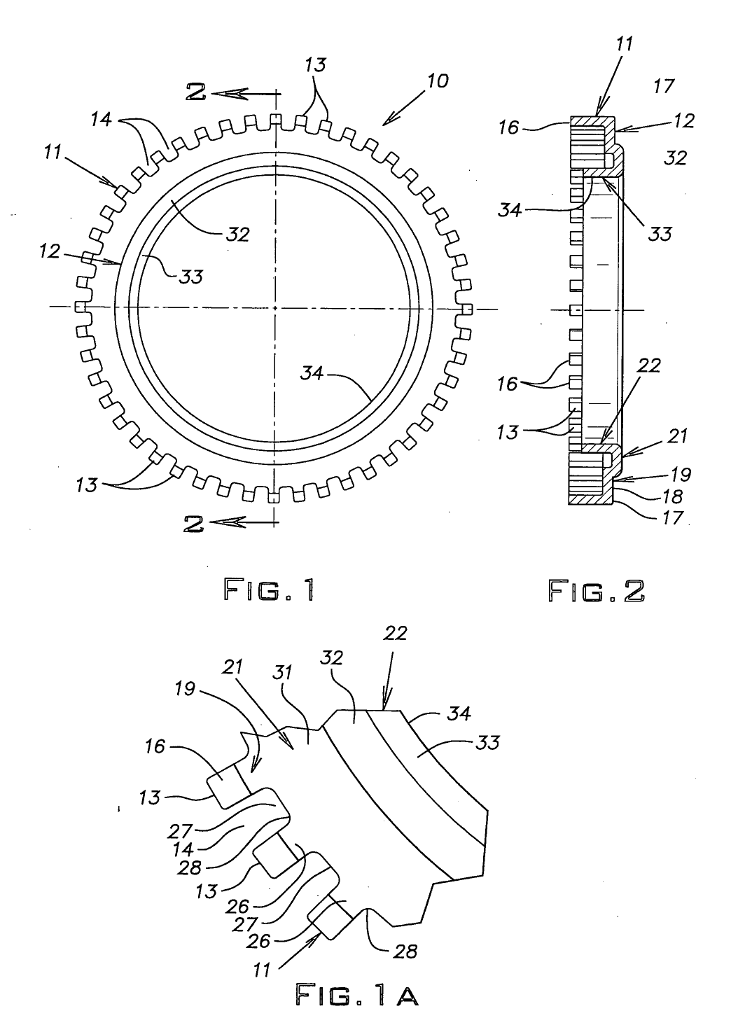

Referring now to FIGS. 1-3, there is illustrated one type of tone wheel 10 constructed in accordance with the present invention. The tone wheel 10 is formed by stamping operations performed on sheet steel stock. By way of example, but not limitation, the metal stock can be low carbon steel 2.49/2.69 mm thick. Because of its iron content, the steel stock is ferromagnetic; additionally, this stock is malleable.

The tone wheel 10 is a unitary annular body having a peripheral or rim portion 11 and a center portion 12 concentric with each other about a common axis. The peripheral portion 11 comprises a multitude, in this example 48, of axially extending essentially identical teeth 13. The teeth 13 are uniformly spaced around the periphery of the tone wheel 10 with essentially identical intervening slots 14. The width of the slots 14 in a circumferential direction is similar to the width of the teeth 13 in the circumferential direction with the width of either the teeth or the slots preferably not being more than twice that of the other. In the illustrated case, but not necessarily, the width of the slots is 3.6 mm while the width of the teeth is 2.6 mm. The cross-section of the teeth 13 in a plane perpendicular to the axis of the tone wheel 10 is rectangular and, preferably, though not necessarily, is nominally square, it being understood that the term rectangular includes the condition of being square. The axial length of the teeth 13 is preferably several times their width. In the illustrated case this length is nominally 10.5 mm measured from a free cantilevered end 16 of a tooth to an inward end 17 of the tooth at an outer face 18 of a radially outer peripheral section 19 of the wheel center portion 12.

The wheel center portion 12 has, besides the radially outer peripheral section 19, an intermediate section 21 and an inner peripheral section 22. The outer peripheral section 19, which lies in a generally flat radial plane transverse to the axis of the tone wheel 12 includes a multitude of circumferentially spaced roots 26 that each support a respective one of the teeth 13. Each root 26 has a width generally equal to the width of a tooth 13 so that, in effect, the root is a radial extension of a tooth. The roots 26 are separated by gaps 27 that are aligned with and merge into the slots 14 between the teeth 13. The depth of each gap 27 below an inner face of a tooth 13 is less than that of the thickness of a tooth and, for example, can be about as large as ½ the tooth thickness. As seen in FIG. 1, the base of a root 26 has a small fillet area 28 at each gap 27.

Radially inward of the roots 26, the intermediate section 21 is preferably, but not necessarily, imperforate. The intermediate section 21 includes a flat part 31 in a radial plane common with the roots 26 and an annular rib or bead 32. The annular bead 32 is stamped or pressed into the intermediate section 21 to improve rigidity so that the body of the wheel 10, as a whole, remains planar or flat.

The inner peripheral section 22 of the center portion 12 has a flange 32 that extends axially from the rib or bead 32 in the same direction as the extension of the teeth 13. The axial flange 33 has a precisely formed cylindrical bore 34 preferably made by an extrusion stamping process. The flange bore 34 is relatively long compared to the thickness of the sheet stock from which the wheel 10 is made so that when assembled onto a shaft or other rotating part, it is sufficiently rigid and stable. The bore 34, in the illustrated example, is nominally 10 mm long as compared with the gauge thickness of the wheel at nominally 2.6 mm thick. The outside diameter of the wheel 10 across the outer surfaces of the teeth 13 is nominally 94.4 mm for purposes of illustration but not limitation.

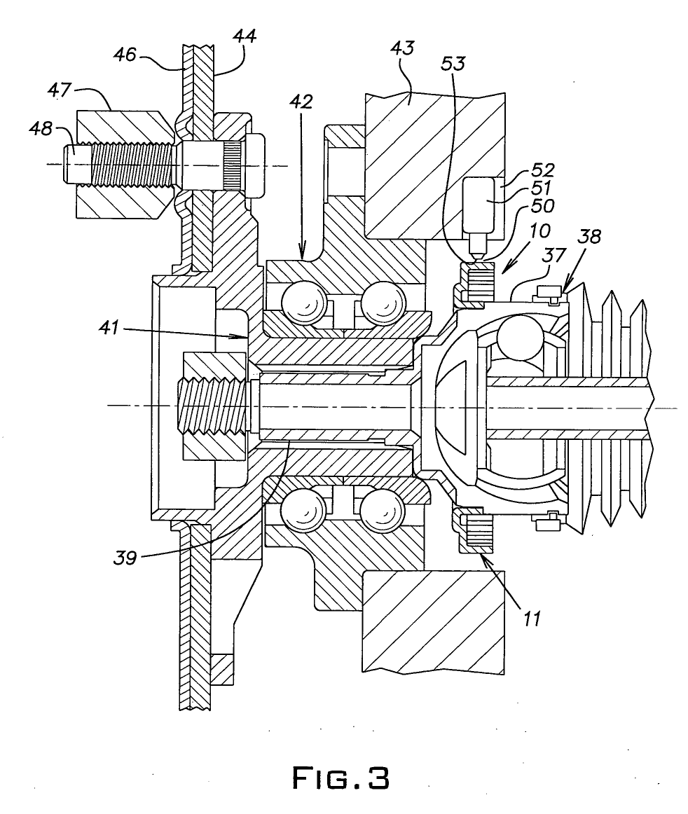

FIG. 3 illustrates the tone wheel 10 in a typical assembled condition on a wheel suspension system on a land vehicle such as a passenger vehicle, sport utility vehicle, pick-up truck, or similar vehicle. The tone wheel 10 is mechanically coupled to a road wheel 46 (fragmentarily shown in FIG. 3 and understood to carry a conventional tubeless tire or equivalent) by fixing it to a rotating member that turns with the wheel. More specifically, in the illustrated case, the tone wheel 10 is fixed on the exterior of a housing 37 on an outer constant velocity joint 38 that is part of a front drive shaft that, when being driven, power rotates the road wheel 46 through its output spline 39. The spline 39 rotates a hub assembly 41 journalled for rotation in a bearing assembly 42 carried in a steering knuckle 43 forming part of the front suspension of a vehicle in a generally conventional arrangement. A brake rotor 44 and the road wheel 46 are carried on the hub assembly 41. Lug nuts 47 threaded onto studs 48 fix the wheel 46 and brake rotor 44 on the hub assembly 41.

A sensor 51 of known construction is retained in a pocket or bore 52 in the steering knuckle 43 by a suitable bolt or clamp (not shown) in a known manner. The sensor 51 is located relatively close to the periphery of the tone wheel 10. A gap 50 between a face 53 of the sensor 51 and the periphery of the tone wheel 10 formed by the outside surface of the teeth 13 can range between near contact to about 1 mm. By way of example, but not limitation, the sensor 51 “sees” or scans an area on the periphery of the tone wheel 10 that is about 2.5 mm square. The sensor 51 reacts to the presence or absence of a tooth 13 in the space near it in a known manner to produce a pulsed electrical signal. The time between pulses is proportional to the rotational speed of the tone wheel 10 and this data is used in a brake system to determine if a wheel is skidding so that braking forces can automatically be adjusted.

The tone wheel 10 is preferably press fit onto the exterior of the constant velocity joint housing 37 of the axle with a sufficiently tight fit to assure it will remain in place during normal service. If desired, the tone wheel 10 can be fixed in place by other techniques such as by the use of welding, adhesives, fasteners or other types of retainers rather than by a press fit or to supplement a press fit. As FIG. 3 illustrates, the tone wheel 10 is exposed to the atmosphere and environment of the road wheel 46. No seal or seals exist to isolate the tone wheel 10 from this environment. The disclosed tone wheel 10, with its open teeth 13, has demonstrated several advantages over conventional tone wheels such as the solid gear-like type formed of powdered metal. The tone wheel 10 of the invention is more cost effective, lighter, stronger and capable of producing a “sharper” signal than this common powdered metal type of tone wheel. The signal sharpness is at partially least attributable to the configuration of the teeth wherein they have no roots or underlying supporting material in all or most of the area to which the sensor is magnetically responsive. Where the scanned area is about 2.5 mm square and the sensor 51 is at about mid-length of the teeth 13 that are, for example, 10 mm long, the roots 26 and other parts of the center portion 12 are out of range of detection by the sensor. Thus, there is no significant fuzzy advance or retarding of the signal phenomena contributed by the approach of a tooth root zone to and from the area of sensitivity of the sensor 51.

Stated in other words, as disclosed, the length of the teeth 13 is large in comparison to the area in which the sensor is magnetically sensitive. This feature enables the roots 26 on the center portion 12 to be offset (in the axial direction of the tone wheel 10) a sufficient distance from the area in which the sensor is most sensitive so that little or no blurring or degradation of the signal produced by the cantilevered teeth 13 occurs through influence of the roots 26.

The disclosed tone wheel 10 has the additional advantage of reducing the risk of damage to the sensor 51 which has occurred with prior art tone wheel designs where dirt and debris accumulates in the circumferential space between teeth. In some instances, solid particulate material carried by prior art tone wheels has abraded or impacted the sensor causing it to fail. The described tone wheel 10 of the invention is self-cleaning and, consequently, reduces the risk of this type of damage to the sensor 51. The teeth 13, in the axial zone sweeping by the sensor, are unsupported radially below themselves and are spaced from the housing 37 of the axle joint 38 supporting the tone wheel. As a consequence of this cantilever support, air can circulate through the slots 14, propelled by centrifugal force, to sweep dust and other contaminants away from the teeth. Additionally, any particulate material finding its way onto the periphery of the tone wheel easily passes through the slots 14 without harmfully abrading or impacting the sensor 51.

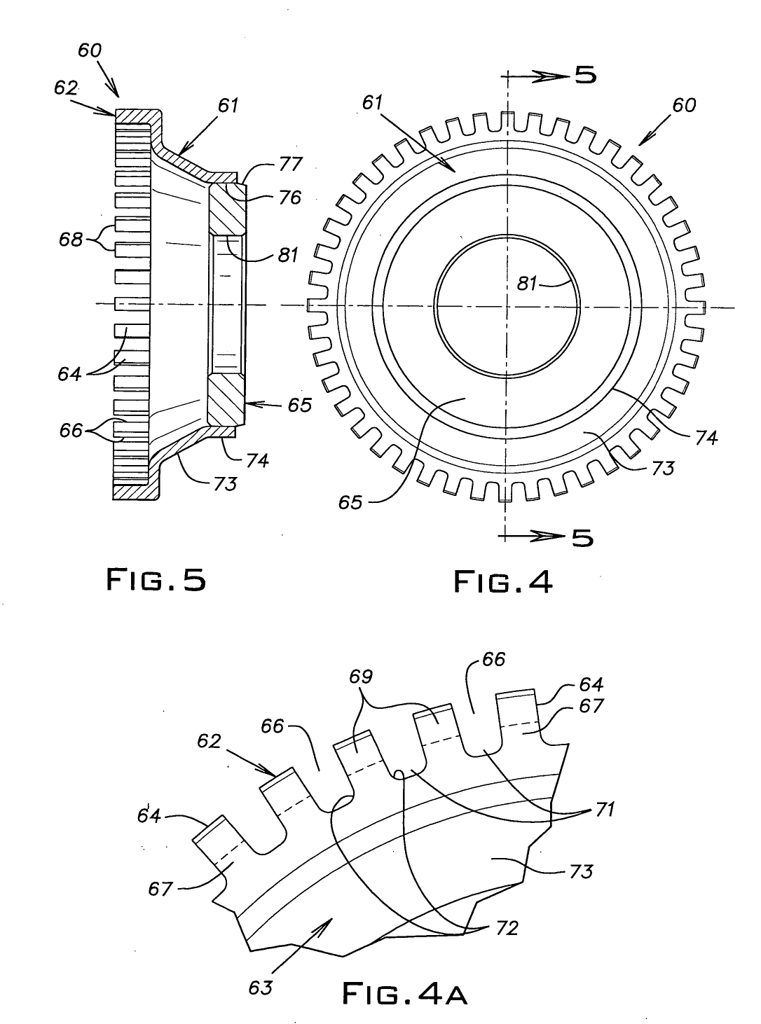

Referring now to FIGS. 4-6, there is shown another embodiment of a tone wheel 60 constructed in accordance with the invention. The tone wheel 60 comprises two annular coaxial parts 61 and 65. A sheet-steel shell part 61 is similar in construction to the tone wheel 10 described above and is economically formed as a steel stamping. By way of example, but not limitation, the shell 61 can be formed of low carbon steel, 2.69/2.49 mm thick. The shell 61 has a rim or outer peripheral portion 62 and a center portion 63. The outer peripheral portion 62 comprises a multitude of axially extending essentially identical teeth 64 separated by essentially identical slots 66. The illustrated wheel has 44 teeth and an outside diameter of 88 mm. Each tooth 64 has a rectangular cross-section which, in the illustrated case, is square. The teeth 64 are cantilever supported on respective roots 67 formed in an outer peripheral section of the center portion 63. The length of the teeth 64 from a free end 68 to a supported end 69 with a face coplanar with the plane of outer faces of the roots 67.

The roots 67 extend in radial planes and have cross-sections like that of the teeth 64. Gaps 71 between the roots 67 are aligned with the slots 66. Fillets 72 are formed on both circumferential sides of the roots. The radial length of the roots 67 from the inside faces of the teeth 64 is about ⅔ of the radial thickness of a tooth; this length being about 1.8 mm while the radial tooth thickness is nominally 2.6 mm, for example, but not by way of limitation. The center portion 63 includes a conical mid-section 73 and an inner peripheral section 74. The inner peripheral section 74 has an axial bore 76 that is sized to fit on a cylindrical outside diameter surface 77 of the collar 65. The bore 76 has an axial length that is preferably at least about three times the wall thickness of the shell 61 (i.e. about 8 mm) to ensure that it will seat on the collar 64 in a stable rigid manner. The shell 61 is preferably retained on the collar with a press fit. Other retaining techniques such as adhesive bonding, brazing, welding and the like can be used to augment the press fit or to substitute for it.

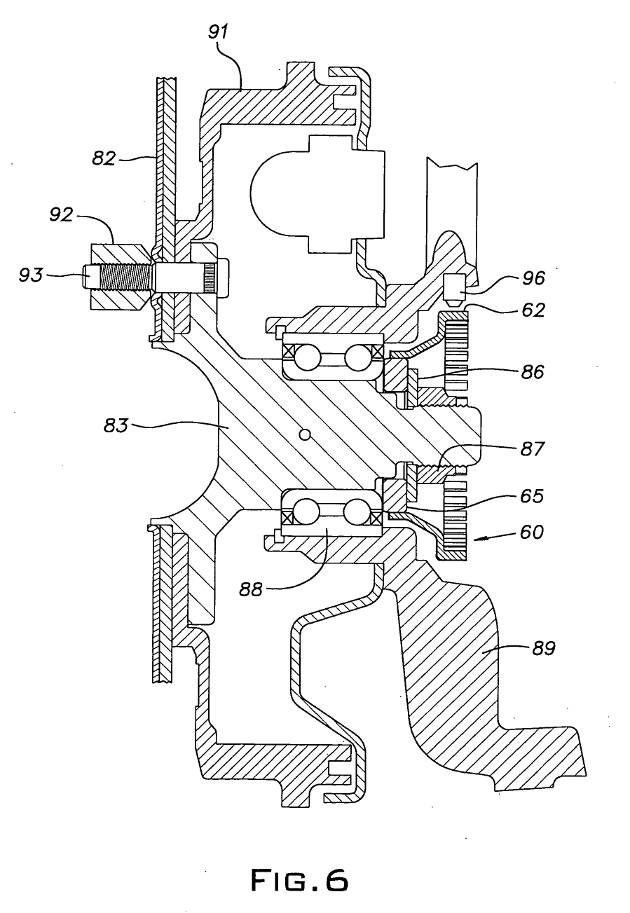

The collar 65 is preferably formed of a steel with suitable compressive yield strength. As shown, the collar 65 has a cylindrical inside diameter surface or bore 81 concentric with the outside surface 77. FIG. 6 illustrates the tone wheel 60 in assembled relation to a road wheel 82 of a vehicle such as a passenger car, sport utility vehicle, utility van, pick-up truck and the like. The tone wheel 60 is retained and angularly locked on a spindle or hub assembly 83 by a washer 86 and retaining nut 87 threaded onto an inboard end of the spindle 83. The spindle 83 is journalled in a bearing assembly 88 carried in an axle 89 of the vehicle. In the illustrated case, the axle 89 is a rear axle and the spindle 83 is not driven directly by the engine and transmission of the vehicle but, rather, is free-wheeling. The road wheel 82 and a brake drum 91 are retained on the spindle or hub assembly 83 by lug nuts 92 threaded onto studs as is customary.

It will be understood from the foregoing that the tone wheel 60 rotates in synchronization with the road wheel 82. A sensor 96, suitably mounted in the axle 89 closely adjacent the periphery of the tone wheel 60 senses the motion of the teeth 64 to generate electrical pulses at a rate proportional to the speed of the wheel 82. These pulses, as described above, are used with other information to detect wheel skid. The tone wheel 60, like the earlier described tone wheel 10, is open to the atmosphere of the road wheel 82. The open character of the teeth 64, being free of material in a zone between and radially inward of the teeth along the majority of the length of the teeth allows the tone wheel 60 to be self-cleaning or self-purging of dust and debris by centrifugal air flow and by passage of particulate material between adjacent teeth. It should be noted that both disclosed tone wheels 10, 60 have their teeth spaced radially outwardly of any spindle or axle surface so that the possibility of a build-up of dirt and debris on such circumscribed surfaces to the point of fouling the space between the teeth is reduced. Thus, the tone wheels 10, 60 reduce the risk of harm to the sensors 96 by abrasion or impact with material carried on a tone wheel.

While the invention has been shown and described with respect to particular embodiments thereof, this is for the purpose of illustration rather than limitation, and other variations and modifications of the specific embodiments herein shown and described will be apparent to those skilled in the art all within the intended spirit and scope of the invention. For example, where the application dictates, the elongated teeth, while generally axially oriented, can have their longitudinal axes forming a limited angle of, for example, up to about 20°, with the rotational axis of the wheel. Accordingly, the patent is not to be limited in scope and effect to the specific embodiments herein shown and described nor in any other way that is inconsistent with the extent to which the progress in the art has been advanced by the invention.

What is claimed is:

1. A tone wheel for signaling the rotational speed of a wheel in a land vehicle comprising a unitary body formed of sheet steel, the body including a center portion and a rim portion radially outward of the center portion and concentric about a central axis, the rim portion having a multitude of elongated substantially identical generally axially oriented teeth, each tooth being separated from adjacent teeth by slots of substantially identical width, each tooth having a generally rectangular cross-section in a plane perpendicular to its longitudinal axis, the width of a tooth being substantially less than the length of a tooth and the width of a slot being similar to the width of a tooth, the center portion having a periphery formed by generally radially extending roots each supporting a respective one of said teeth, said roots being arcuately spaced from one another by gaps that merge with associated ones of said slots.

2. A tone wheel as set forth in claim 1, wherein said roots each have a cross-section in a plane perpendicular to a line radial to the axis that is substantially the same as the cross-section of a tooth.

3. An assembly for a land vehicle comprising a wheel suspension structure including a spindle for supporting a road wheel, a tone wheel having a central axis and being mechanically coupled to the spindle in a manner such that it rotates coaxially with the spindle, the tone wheel being adjacent the spindle and being in a zone open to the environment of the road wheel, the tone wheel having a unitary body formed of sheet steel, the body including a center portion and a rim portion radially outward of the center portion, the rim portion having a multitude of elongated substantially identical axially oriented teeth, each tooth being separated from adjacent teeth by slots of substantially identical width, each tooth having a generally rectangular cross-section in a plane perpendicular to the central axis, the width of a tooth being substantially less than the length of the tooth and the width of a slot being similar to the width of a tooth, the center portion having a periphery formed by generally radially extending roots each supporting a respective one of said teeth, said roots being arcuately spaced from one another by gaps that merge with associated ones of said slots, said center portion supporting each of said teeth at one end through said roots while an opposite end of each of said teeth is free of direct support in the manner of a cantilever, a sensor carried on said structure in close proximity to the periphery of the tone wheel and generally centered on the axial length of the teeth and adapted to produce a signal indicating the rotational speed of the tone wheel and, therefore, the road wheel, the open character of the slots enabling the tone wheel to be self-cleaning of dust and debris both through radially outward passage of air and radially inward passage of solids through the slots so that the risk that the sensor will be abraded or struck by foreign material carried on the wheel is reduced.

4. An assembly as set forth in claim 3, wherein said center portion has a hub with a cylindrical flange.

5. An assembly as set forth in claim 4, wherein said flange is press fit over a cylindrical surface.
